(19) United States
(12) Patent Application Publication
(10) Pub. No.: US 2012/0097141 A1
(43) Pub. Date: Apr. 26, 2012

(54) TWO-STROKE ENGINE WITH A COMPRESSED-AIR-ASSISTED FUEL-INJECTION SYSTEM

(75) Inventor: Nicola CERRETO, Bagnolo in Piano (RE) (IT)

(73) Assignee: EMAK S.P.A., Bagnolo in Piano (RE) (IT)

(21) Appl. No.: 13/273,883

(22) Filed: Oct. 14, 2011

(30) Foreign Application Priority Data
Oct. 22, 2010 (IT) RE2010A000088

(51) Int. Cl. F02B 33/04

(52) U.S. Cl. 123/73 AA

(57) ABSTRACT

A two-stroke internal combustion engine is provided and includes a casing, a cylinder, a piston skirt, an aspirating port, a carburetor which supplies the casing with an air/fuel mixture, through said aspirating port, a transfer conduit which opens into the cylinder through an air/fuel inlet port, and a fuel storage system, or resonance tube which communicates with a first port located above the aspirating port, and with a second port located below the aspirating port. The first port and the second port are alternatingly opened by the piston skirt, which includes a through-hole having a diameter between 0.5 and 3.0 mm. The through-hole being located, when the piston is mounted in the engine, in a same radial plane as the second port.

### FIELD OF THE INVENTION

The present invention relates to two-stroke engines and, in particular, to two-stroke engines where the fuel injection takes place under pressure thanks to a resonating wave induced in a tube leading from the motor casing to an injection port located in the cylinder.

### BACKGROUND OF THE INVENTION

In usual two-stroke engines the air/fuel mixture enriched with lubricating oil is supplied through a usual carburetor in the base or casing of the engine where the crankshaft is located.

A piston moving alternatingly in the cylinder communicating with the base, induces a regime of pulsating pressure therein, the maximum pressure coinciding with the position of the piston in proximity of the bottom dead centre, hereinafter BDC.

A transfer conduit of the fuel in the cylinder connects a port in the base of the cylinder located in proximity of the engine base with a port, called the inlet port, located in the median area of the cylinder.

A discharge port is located in the cylinder at about the same height as the inlet port, and is offset with respect thereto.

Substantially, during the descent of the piston, the pressure on the upper part of the piston decreases, while the pressure inside the casing increases, which causes the transfer of the air/fuel mixture located therein into the upper part of the cylinder.

When the piston reaches the bottom dead centre, or BDC, the inlet and discharge ports are open and the aspirating port is closed.

When the piston starts to re-ascend towards the top of the cylinder, the piston first closes the inlet port which sets the cylinder in communication with the casing, and then, almost simultaneously, the discharge port; the aspirating port of the mixture inside the casing then opens and the cycle starts again.

The lubrication of the mechanical devices is ensured by a certain percentage amount of lubricating oil added to the fuel.

As the fuel must be supplied to the engine according to a correct stoichiometric ratio, basically the amount of lubricant destined to the lubrication of the organs depends not only on the lubricant added to the fuel, but also on the air/fuel mixture ratio introduced into the casing by the carburetor, which ratio is equal to the stoichiometric ratio.

Two-stroke engines are also known in which, in combination with the above traditional supply system through a carburetor, a supplementary fuel/lubricant injection is provided near the cylinder head.

The supplementary injection system comprises a fuel injection conduit which supplies a storage system, or store, which comprises a storage conduit, also called a resonance tube, which exhibits a first port and a second port communicating with the cylinder respectively above and below the mixture inlet port in the cylinder. The piston skirt opens and closes the two ports in succession while the piston moves alternatingly in the cylinder.

Before being injected into the cylinder through the upper port, the fuel is stored in the resonance tube system from where it is injected into the cylinder by means of a pressure wave generated in the tube by the combustion of the mixture in the cylinder.

The pressure wave penetrates the resonance tube through the upper port, flows through it until reaching the lower port and, from there, flows up the tube, entraining with it the fuel, which is in this way injected into the cylinder.

Usually, the injection of the fuel into the cylinder takes place when the piston reaches the BDC or immediately prior thereto.

The amount that is stored in the resonance tube, before the injection into the cylinder, is batched by known means.

The above injection system is described in document EP 1856387 in the present applicant's name.

To sum up, starting from the top of the cylinder the following ports are present in the cylinder liner:

first (upper) port in the resonance tube,

transfer port,

discharge port,

aspirating port,

second (lower) port in the resonance tube.

During the motion of the piston the ports are respectively open (A)/closed (C), by the piston liner, as indicated in the following chart.

| | Position of the piston | | | |
|---|---|---|---|---|
| | | 1^{ST} | 2^{ND} | |
| | TDC | position | position | BDC |
| First upper port | C | C | A | A |
| Transfer | C | C | C | A |
| Discharge | C | C | A | A |
| Aspirating | A | C | C | C |
| Second lower port | A | A | C | C |

As the stoichiometric ratio between fuel and comburent air in the cylinder head must be essentially constant for correct running of the engine, the amount of fuel contained in the mixture supplied by the carburetor at the base of the engine is lower than that of traditional engines, i.e. the air/fuel mixture is leaner, when we take account of the further amount of fuel introduced in the cylinder head by an injection system.

Since the only lubricant which reaches the crankshaft, and relative kinematism, is that which is added to the fuel supplied by the carburetor, in the engines of the type described above these organs are not sufficiently lubricated, due to a reduced amount of fuel and lubricating oil contained in the mixture supplied at the base.

### SUMMARY

The aim of the present invention is to remedy the above-mentioned drawbacks in the ambit of a simple, relatively economical and reliable solution.

The aim is attained by the engine thanks to the characteristics recited in the first independent claim; the dependent claims recite other characteristics aimed at improving the results of the invention.

In substance, the invention comprises realisation of a port in the piston skirt, which port, during the alternative motion of the piston, cyclically coincides with the second lower port which sets the cylinder in communication with the resonance tube.

The port must be sufficiently small such as not to substantially modify the pressure regimes on both the sides of the piston.

The dimensions of the port are advantageously comprised between 0.50 mm and 3.00 mm, preferably between 1.50 and 2.50 mm.

In this way the organs in the casing which are below the piston are cyclically struck by a jet of fuel with lubricant added, and they are duly lubricated by it.

If, during the alternating motion, the port in the cylinder head moves in front of the aspirating port, the port in the cylinder might negatively interfere with the carburetor engine fuel supply.

For this reason, the port should preferably lie on a generatrix of the piston skirt other than a generatrix thereof facing the aspirating port, in order to overlap minimally or not at all with the aspirating port.

As the amount of fuel injected through the upper port of the resonance tube can be determined during the design stage, it is possible with this type of engine to supply all the fuel through injection, and to introduce only comburent air into the casing.

### BRIEF DESCRIPTION OF THE DRAWINGS

The advantages and constructional and functional characteristics of the invention will more fully emerge from the detailed description that follows, illustrated in the figures of the accompanying tables of drawings and relating to a preferred embodiment of the invention, given by way of non-limiting example.

FIG. 1 illustrates the engine in a partially-sectioned lateral view with the piston at BDC;

FIG. 2 illustrates the section of FIG. 1 in a different operative operation, with the piston ascending towards TDC.

FIG. 3 illustrates section III-III of FIG. 2.

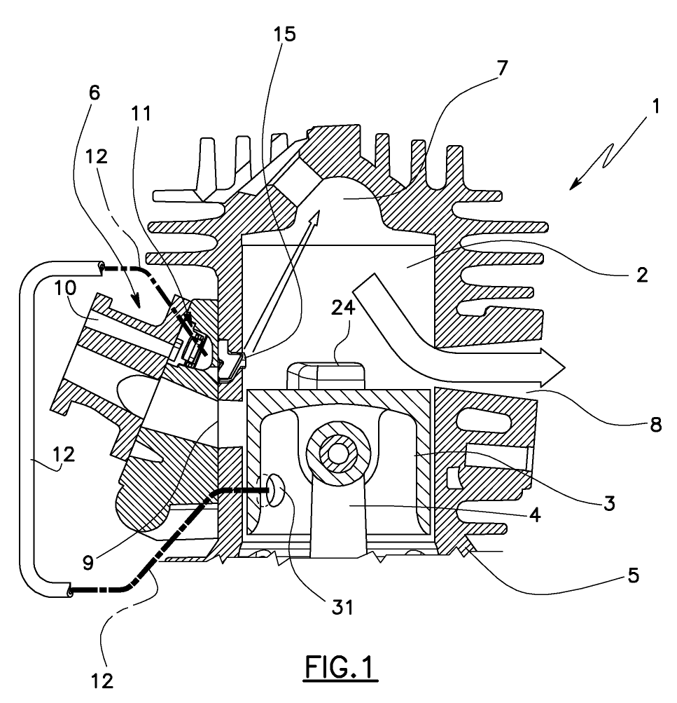

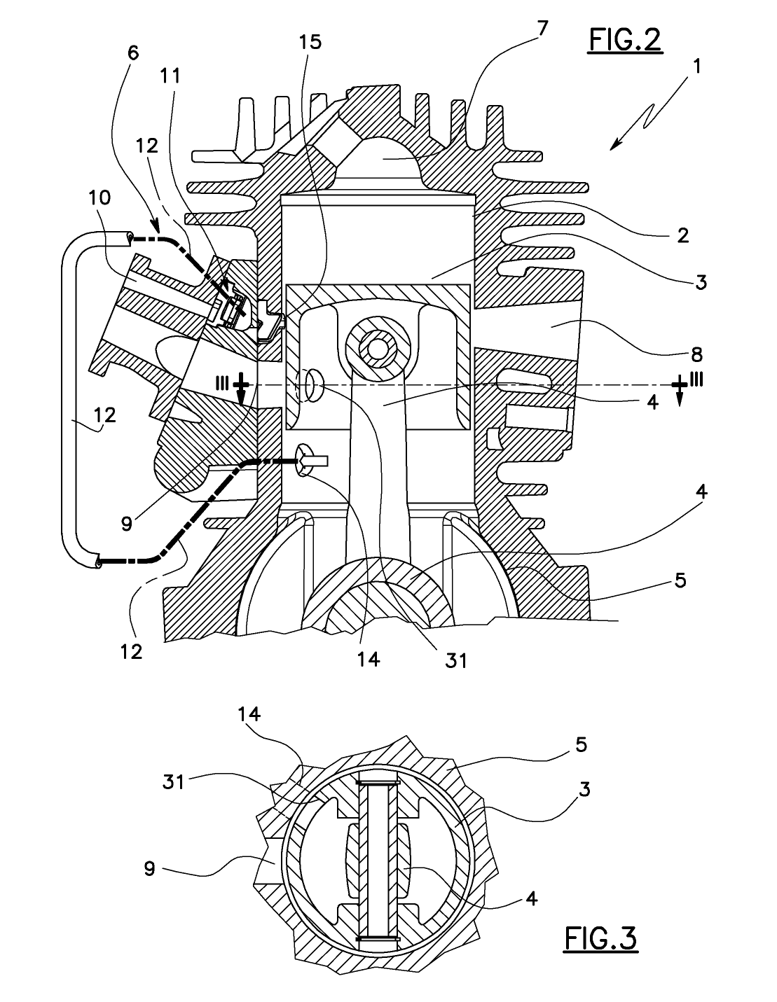

### DETAILED DESCRIPTION OF THE PREFERRED EMBODIMENTS

The figures illustrate a two-stroke engine 1 comprising a cylinder 2, a piston 3, a con rod 4 connected to the crank, a casing 5, a transfer conduit 24 between the casing 5 and the cylinder 2, and a fuel-injection system 6.

The cylinder 2 exhibits a head 7 to which is attached a sparking plug (not shown), and it freely communicates with the casing 5.

The combustion chamber 7 is afforded in the head.

The discharge port 8 and the air/fuel mixture aspirating port 9 are located practically halfway up the cylinder 2 and are reciprocally offset.

The fuel is sent to the aspirating port by a usual carburetor which is not illustrated.

A fuel-supply conduit 10 communicates with the injection system.

The injection system comprises a resonance tube 12 communicating with a second port 14 located at the base of the cylinder in proximity of the casing 5 and a first port 15 communicating with the middle area of the cylinder 2, the first and second ports 15, 14 being located respectively above and below the mixture aspirating port 9.

The piston skirt 3 is fashioned such that during the rising of the piston the second port 14 and the first port 15 are successively opened, and vice versa, as illustrated in the chart herein above.

The storage conduit (or resonance tube) 12 further communicates with a recess fashioned such as to snugly house the valve means 11 near the first port 15, the valve means 11 intercepting the fuel-supply conduit 10 and batching the fuel.

In the invention, the piston 3 comprises a through-conduit, or port 31, which is located in the same radial plane as the port 14.

In the illustrated example the port 31 has a diameter of 2.5 mm.

When the port 31 transits past the port 14, a portion of the fuel in the transfer tube 12 is drawn away by the pressure wave therein, enters the piston cavity through the port 31 and thus improves the lubrication of the organs located inside the piston and the casing.

The port 14 is located in a radial plane that is different to the plane of the aspirating conduit 9.

Thanks to the small dimensions of the port 31, only a portion of the fuel drawn into the resonance tube through the port 15 flows out of the port 31, the remaining portion being supplied to the cylinder head through the port 15.

Thanks to the invention the set aims of obtaining an improved lubrication of the kinematism contained in the base and inside the piston are attained.

It is understood that the invention is not limited to the example described herein, and variants and improvements thereto can be applied without its forsaking the ambit of the following claims.

What is claimed is:

1). A two-stroke internal combustion engine (1), comprising a casing (5), a cylinder (2), a piston skirt (3), an aspirating port (9), a carburetor which supplies the casing (5) with an air/fuel mixture, through said aspirating port (9), a transfer conduit which opens into the cylinder through an air/fuel inlet port (24), and a fuel storage system, or resonance tube (12) which communicates with a first port (15) located above the aspirating port (9), and with a second port (14) located below the aspirating port (9), the first port and the second port (15, 14) being alternatingly opened by the piston skirt (3), which comprises a through-hole (31) having a diameter between 0.5 and 3.0 mm, the through-hole (31) being located, when the piston is mounted in the engine, in a same radial plane as the second port (14).

2). The engine of claim 1, wherein the through-hole (31) in the piston skirt has diameter of 1.50 mm.

3). The motor of claim 1 wherein, when the piston is mounted on the engine, the through-hole (31) is located in radial plane which is different from that of the aspirating port (9).
